(19) United States
(12) Patent Application Publication
(10) Pub. No.: US 2007/0000353 A1
(43) Pub. Date: Jan. 4, 2007

(54) Vehicle lube filter unfastening fixture

(76) Inventor: Min-Chi Yu, Taichung City (TW)

Correspondence Address: BIRCH STEWART KOLASCH & BIRCH, PO BOX 747, FALLS CHURCH, VA, 22040-0747, US

(21) Appl. No.: 11/158,052

(22) Filed: Jun. 22, 2005

(51) Int. Cl. B67B 7/00; B25B 13/18

(52) U.S. Cl. 81/3.4; 81/128

(57) ABSTRACT

A vehicle lube filter unfastening fixture includes a bottom plate which has two opposing slots each allows a L-shaped clamping plate sliding therein. The clamping plate has one end vertically extended below the slots and exposed to form a clamping surface and another end extended horizontally in contact with the bottom plate to form a control surface. Two spacers are provided to confine the left and right sides of the control surface which has an aperture to couple with a lower end of a N-shaped control bar. The control bar has an upper end coupling with a blind cavity formed on the bottom of a top plate which has a recess on the bottom to house the control bar, and a top portion to be coupled with a T-shaped wrench and driven thereof. The clamping plate may be driven to synchronously clamp a lube filter.

### FIELD OF THE INVENTION

The present invention relates to a tool for unfastening a vehicle lube filter and particularly to an unfastening tool that is capable of preventing slipping and wearing of tool elements.

### BACKGROUND OF THE INVENTION

Removing a vehicle lube filter generally requires a special tool. FIG. 1 shows a conventional unfastening pliers which includes handles 1 to be gripped by hands and two jaws 2a and 2b on the left side and right side of the front end. One jaw 2a is to be pivotally coupled on an annular chain 3. The chain 3 has a chain pin 5 on every two links 4 that has one end extended to be coupled with a latch hook 6 of another jaw 2b. For removing the lube filter, the annular chain 3 is coupled on the outer side of the lube filter. The jaw 2b is latched on the desired chain pin 5 according to the size of the lube filter to clamp the lube filter. The chain 3 and the handles 1 are located on the same horizontal position. As the engine room of the vehicle is packed with other elements and the space is limited, operation of the pliers is difficult and time-consuming. Moreover, the pitch between the chain pins 5 of the links 4 are constant. Adjustment of the link 4 to match the size of the lube filter often is not possible. For instance, if the size of the lube filter and length of the chain differ by one half of the link 4, the chain 3 cannot clamp the lube filer securely.

To remedy the aforesaid problem, new lube filter unfastening tools have been developed. R.O.C. Patent Publication No. 257128, entitled “Three-claw lube filter unfastening fixture” is such an example. Referring to FIGS. 2, 3 and 4, it includes a triangular top plate 1c and a corresponding bottom plate 2c. The bottom plate 2c has a center gear 11c pivotally mounted onto an inner wall. The center gear 11c has a circular collar 12c formed thereon. The circular collar 12c may be coupled with a round opening 21c formed on the top plate 1c. The circular collar 12c has a square strut formed thereon to be coupled with a T-shaped wrench 4c. There are three longitudinal claws 3c located on the periphery of the center gear 11c in an equally spaced manner. Each of the claws 3c is directed downwards and is bent horizontally inwards for 90 degrees to hold a gear 31c to engage with the center gear 11c. The top plate 1c is fastened to the bottom plate 2c through three screws. The three claws 3c are extended outside the three sides of bottom plate 2c.

When in use, the T-shaped wrench 4c is coupled on the square strut of the circular collar 12c and turned to drive the center gear 11c synchronously. The gears 31c on the three claws 3c also are driven and turned at the same time. As a result, the three vertical claws 3c are swayed. One side of swayed claws 3c clamps the peripheral surface of the lube filter a so that the lube filter a may be removed.

However, as the peripheral surface of the lube filter a is easily smeared by oil, the three swayed claws 3c form a point contact with the peripheral surface of the lube filter a, and often cannot provide an adequate gripping force to remove the lube filter a. Moreover, when the T-shaped wrench 4c receives a force for turning, the claws 3c easily slip. In addition, the force has to be transmitted from the T-shaped wrench 4c to the claws 3c through the gears 31c. These results in diminishing of the force and the gears 31c are easily worn off.

### SUMMARY OF THE INVENTION

Therefore the primary object of the present invention is to provide a vehicle lube filter unfastening fixture that includes a bottom plate and a top plate. The bottom plate has two corresponding slots each allows a L-shaped clamping plate sliding inside. The L-shaped clamping plate has one end vertically extended below the slot and exposed to form a clamping surface, and another end extended horizontally in contact with the bottom plate form a control surface. Two neighboring control surfaces are interposed by a spacer. The control surface has an aperture to couple with a lower end of a N-shaped control bar. The control bar has an upper end coupling with a blind cavity formed on the top plate. The top plate has a recess to house the control bar. The top plate has a top end coupled with a T-shaped wrench to drive the clamping plates synchronously to grip a lube filter. The invention thus formed has a greater clamping section and can provide a firmer gripping force to do unfastening function.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional lube filter unfastening tool.

FIGS. 2, 3 and 4 are schematic views of the “Three-claw lube filter unfastening fixture” disclosed in R.O.C. Patent Publication No. 257128.

FIG. 5 is an exploded view of an embodiment of the invention.

FIG. 6 is a top view of an embodiment of the invention after removed.

FIG. 7 is a sectional view of an embodiment of the invention after assembled.

FIG. 8A is a schematic view of an embodiment of the present invention in an operating condition.

FIG. 8B is a schematic view of an embodiment of the present invention in another operating condition.

FIG. 9 is an exploded view of another embodiment of the invention.

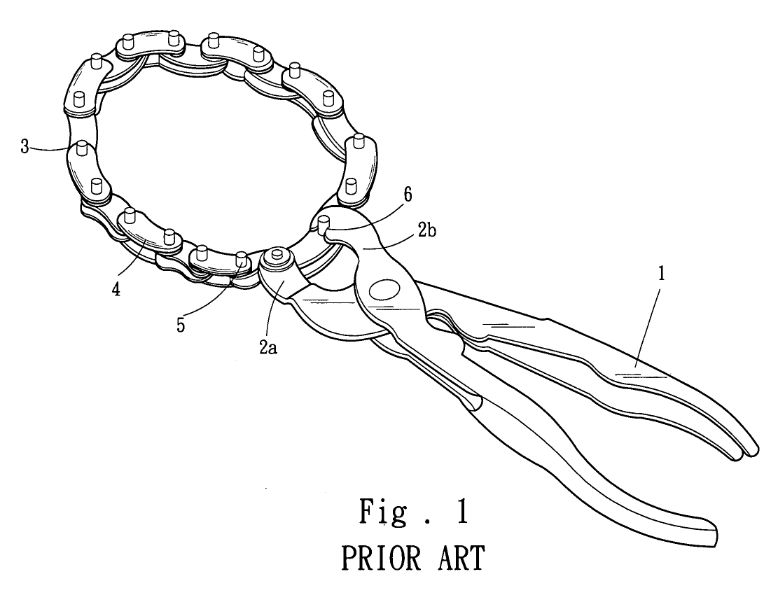

### DETAILED DESCRIPTION OF THE PREFERRED

### Embodiments

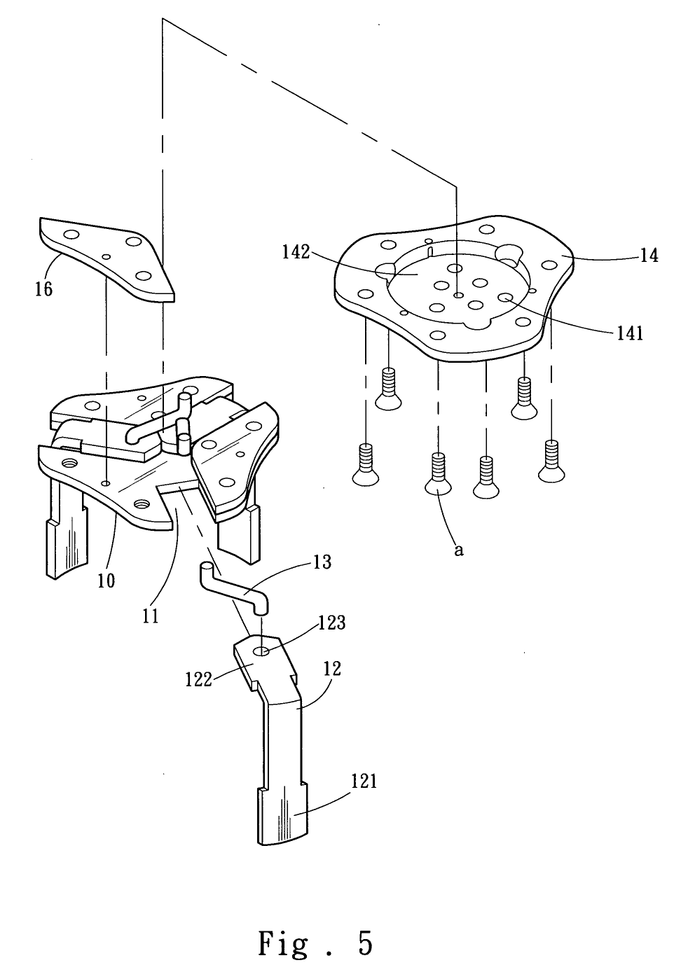

Please refer to FIG. 5, the vehicle lube filter unfastening fixture according to the invention includes:

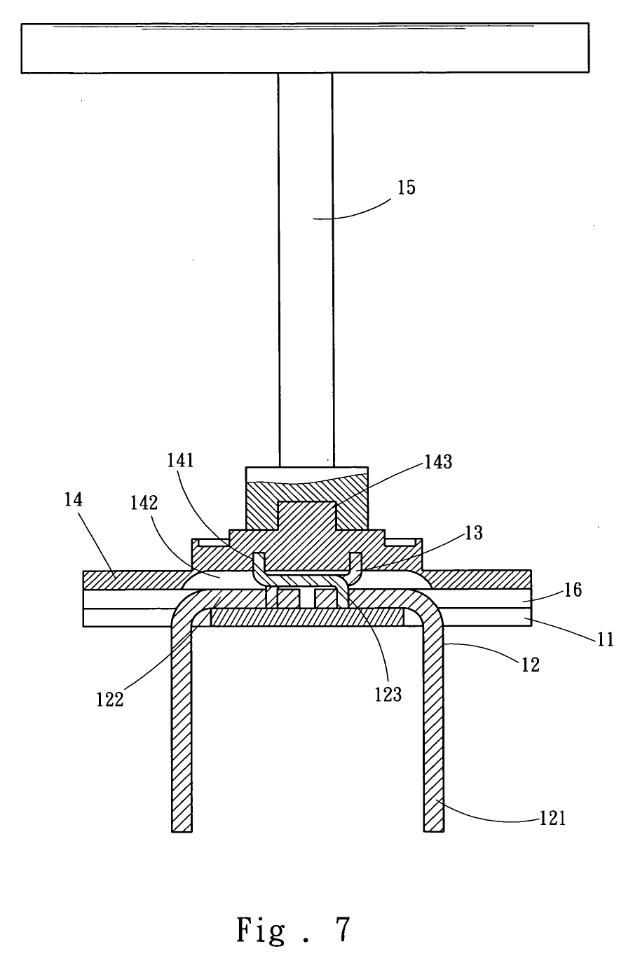

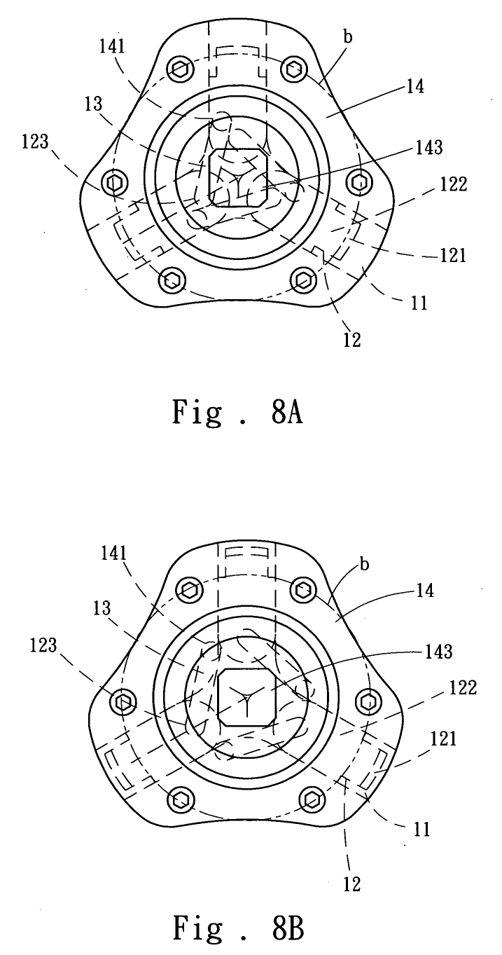

A bottom plate 10 which is a triangular plate made of metal. It has an arched edge formed by every two neighboring sides. The arched edge has a slot 11 directing towards the center. The slot 11 allows a L-shaped clamping plate 12 to slide inside. The clamping plate 12 has one end vertically extended below the slot 11 and exposed to form a clamping surface 121, another end extended horizontally to be in contact with the bottom plate 10 to form a control surface 122, and a middle portion formed at a width mating the slot 11 and slidable horizontally in the slot 11. The control surface 122 has an aperture 123 to couple with a lower end of a N-shaped control bar 13. The control bar 13 has an upper end inserted into a blind cavity 141 formed on the bottom of a top plate 14. The blind cavity 141 is located on a recess 142 formed in the center of the top plate 14. The recess 142 can house the control bar 13. The top plate 14 is formed in a shape mating the bottom plate 10 and has a polygonal coupling head 143 in the center of the top portion. Referring to FIGS. 7 and 8A, when in use, the coupling head 143 is coupled with and driven by a T-shaped wrench 15. Two neighboring clamping plates 12 are interposed by a triangular spacer 16 which confines the position of the clamping plates 12. The top plate 14 and the bottom plate 10 are fastened together through six fastening elements a (such as screws) which run through the spacer 16.

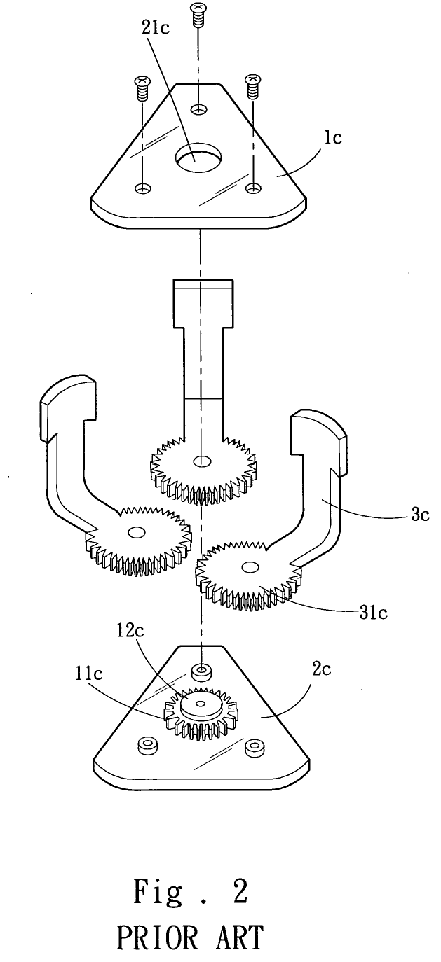

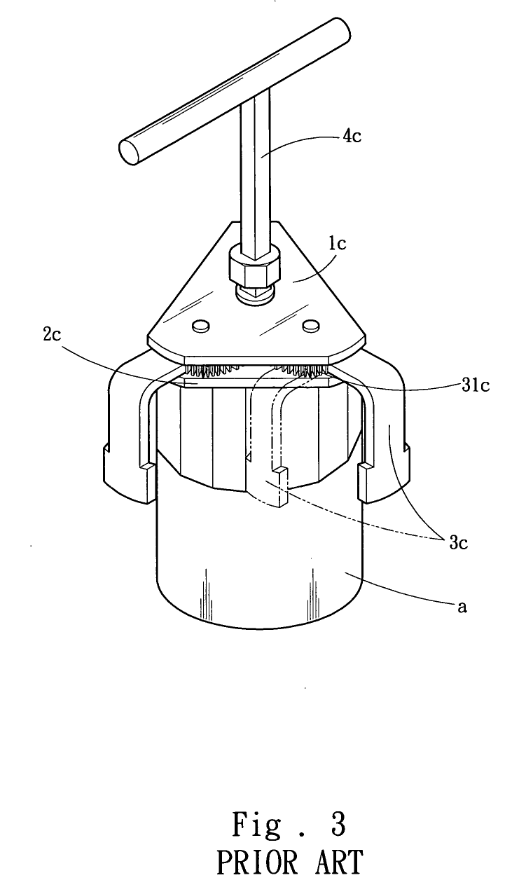

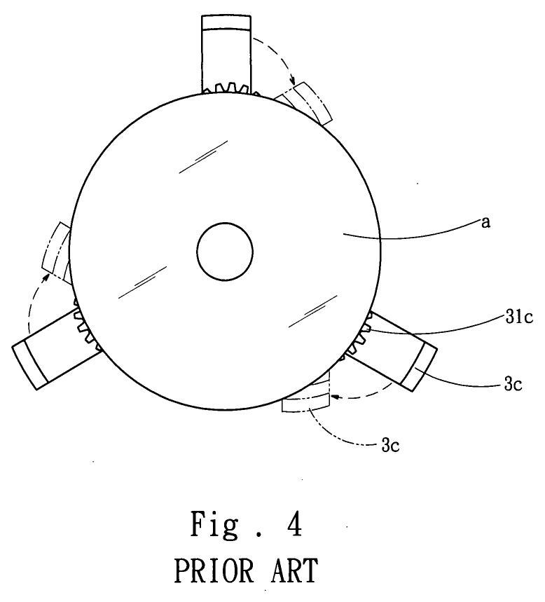

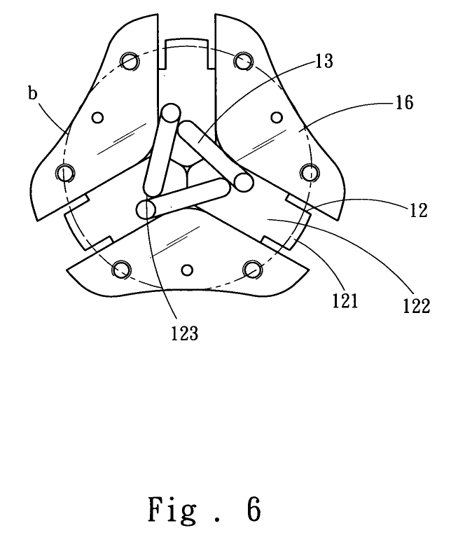

Referring to FIGS. 6 and 7, when the top plate 14 is driven by the wrench 15, the three control bars 13 are inserted into three apertures 123 of the clamping plates 12 and have the top ends coupled with three blind cavities 141 on the bottom of the top plate 14. Hence when the wrench 15 is turned, the top plate 14 is driven and turned synchronously. Referring to FIGS. 8A and 8B, the upper end of each control bar 13 becomes a rotating center, and the lower end is the movable end to drive the clamping plate 12 outwards (or inwards). As the vertical clamping surface 121 of the clamping plate 12 has an inner surface formed in an arched shape, when the clamping surfaces 121 of the three clamping plates 12 are moved synchronously close to the outer surface of a lube filter b, the left and right edges of the clamping surfaces 121 are moved at the same time to clamp the outer surface of the lube filter b, thus have more contact portions to grip the outer wall of the lube filter than the conventional unfastening fixture does (referring to FIG. 2). Therefore the invention can prevent slipping while the wrench 15 is turned. It also does not need gears to transmit the driving power. Hence wearing of elements can be prevented. Moreover, adjustment to suit the lube filter b of different sizes also is easier.

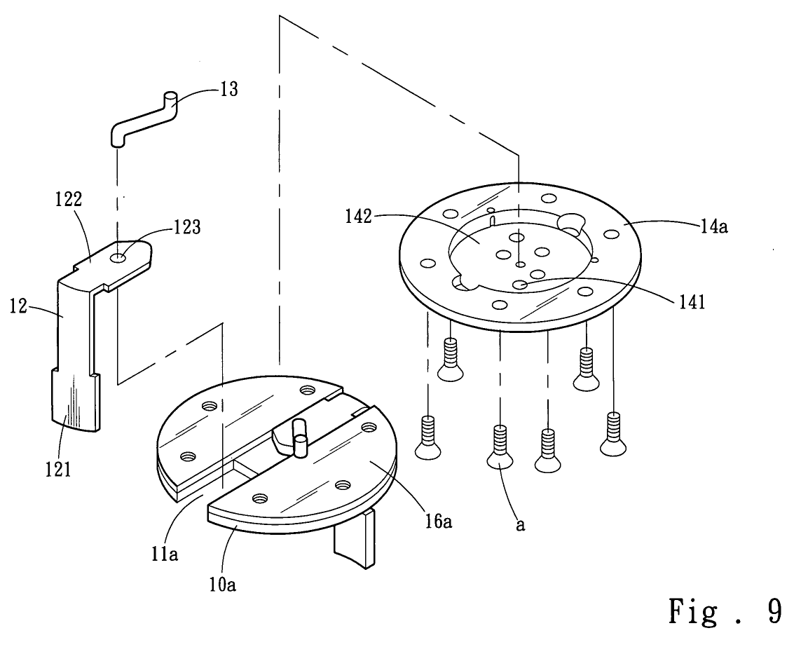

Refer to FIG. 9 for another embodiment of the invention. It has a bottom plate 10a made of metal and formed in a circular plate with two opposite slots 11a in the center. The slots 11a have two ends coupled respectively with the clamping plate 12. The clamping plate 12 has one end vertically extended below the slot 11a and exposed to form a clamping surface 121, and another end extended horizontally in contact with the bottom plate 10a to form a control surface 122. The clamping plate 12 has a middle portion formed at a width mating the slots 11a and slidable horizontally therein. The control surface 122 has a left side and a right side confined by two spacers 16a located on two sides of the slots 11a. The control surface 122 has an aperture 123 to couple with a lower end of a N-shaped control bar 13. The control bar 13 has an upper end to couple with a circular top plate 14a. The top plate 14a has a recess 142 in the center that has two blind cavities 141 to couple with the upper ends of the control bars 13. The top plate 14a is fastened to the bottom plate 10a through a plurality of fastening elements a (such as screws) which run through the spacers 16a. When in use, the two clamping plates 12 clamp the lube filter b at the same time. The operation is same as the embodiment shown in FIG. 5 previously discussed, details are omitted.

The above description is only a better practice example for the current invention, which is not used to limit the practice scope of the invention. All equivalent changes and modifications based on the claimed items of this invention are in the scope of the present invention.

What is claimed is:

1. A vehicle lube filter unfastening fixture, comprising a bottom plate and a top plate that are fastened together through a plurality of fastening elements, the bottom plate having at least two slots to allow a L-shaped clamping plate to slide therein, the clamping plate having one end vertically extended below the slots and exposed to form a clamping surface, and another end extended horizontally in contact with the bottom plate to form a control surface, the control surface having an aperture to couple with a lower end of a N-shaped control bar; the top plate having a recess on the bottom that has at least two blind cavities, each of the blind cavities being coupled with an upper end of the control bar, the recess housing the control bar, the top plate having a top end center to be coupled with and driven by a wrench.

2. The vehicle lube filter unfastening fixture of claim 1, wherein the bottom plate includes at least two opposing spacers on two sides of the slots to confine the control surface, the fastening elements running through the spacers to fasten to the bottom plate.

3. The vehicle lube filter unfastening fixture of claim 1, wherein the top plate has a polygonal coupling head on the top center to be coupled with the wrench.

4. The vehicle lube filter unfastening fixture of claim 1, wherein the clamping plate has a middle portion formed at a width smaller than the clamping surface and the control surface and mating the width of the slots to facilitate sliding.

5. The vehicle lube filter unfastening fixture of claim 1, wherein the clamping surface of the clamping plate has an inner wall formed in an arched shape mating the outer shape of the lube filter.

6. The vehicle lube filter unfastening fixture of claim 1, wherein the bottom plate is formed in a triangular shape that has two neighboring sides forming an arched edge, each of the slots being formed on the arched edge directing towards the center, the two slots being interposed by a triangular spacer which confines two sides of the control surface, the top plate being formed in a shape mating the bottom plate and having three blind cavities in the recess.
